(19) United States
(12) Patent Application Publication
(10) Pub. No.: US 2015/0331145 A1
(43) Pub. Date: Nov. 19, 2015

(54) METHOD FOR PRODUCING A THREE-DIMENSIONAL CHARACTERISTIC MODEL OF A POROUS MATERIAL SAMPLE FOR ANALYSIS OF PERMEABILITY CHARACTERISTICS

(71) Applicant: OBSCHESTVO S OGRANICHENNOY OTVETSTVENNOSTIU "INTROVISION RESERCH AND DEVELOPMENT", Moscow (RU)

(72) Inventors: Evgeniy Aleksandrovich GRACHEV, Moscow (RU); Vadim Gennadievich KULIKOV, Moscow (RU); Andrey Petrovich GORBIK, Moscow (RU); Georgiy Alekseevich KALASHNIKOV, Moscow (RU); Anton Aleksandrovich SARATOV, Moscow (RU); Aleksandr Vladimirovich SHVARTSBERG, Magnitogorsk (RU)

(21) Appl. No.: 14/655,682

(22) PCT Filed: Dec. 25, 2012
(86) PCT No.: PCT/RU2012/001108

§ 371 Date: Jun. 25, 2015

(51) Int. Cl. G01V 99/00; G06F 17/10

(52) U.S. Cl. CPC G01V 99/005; G06F 17/10

(57) ABSTRACT

The present invention relates to a method for producing a three-dimensional characteristic model of a rock sample for analysis of the spatial and physical characteristics of materials subsequent to the processing of images obtained by means of computer tomography. The method includes producing a three-dimensional tomographic image of a sample of material, identifying areas where the structure of the material is homogeneous, assigning a particular material density value to each such area, assigning a particular porosity value to each pixel, assigning a particular absolute permeability value to each pixel, forming a three-dimensional characteristic model on the basis of the porosity and permeability values of each pixel, and calculating the absolute permeability of the entire sample or of a portion thereof in any direction by means of computational fluid dynamics. The technical result is an increase in the precision and reliability of data obtained regarding the permeability characteristics of a sample of porous material, without the need to employ additional financial and labor resources.

### FIELD OF THE INVENTION

The present invention relates to the field of study of porous materials and media properties. More specifically, the invention relates to the method for obtaining characteristic three-dimensional model of a rock sample for further study of its spatial physical properties based on the processed computed tomography (CT) images.

### BACKGROUND ART

Oil and gas deposits lie at various depths in the porous rocks of Earth crust. One of the methods for studying productive formations is the examination of cores—cylindrical rock samples extracted in the process of drilling wells. Rock has multi-scale non-uniform structure. Core analysis allows addressing many crucial issues of field development: petroleum reserves evaluation, recovery method choice, field development economic evaluation, etc.

Nowadays, petroleum engineers face increasingly complicated fields—carbonate formations, shale oil etc. that require more efficient recovery enhancement methods.

Carbonate formation evaluation has its own difficulties resulting from the complex and multi-scale pore space structure, comprising fractures and crevices ranging in size from centimeters to fractions of millimeters and pores ranging in size from tens of nanometers to few micrometers.

Shale stratums exhibit ultra-low permeability of less than 1 millidarcy as well as significant share of closed porosity and kerogen, hard organic matter. These factors make shales ultra-difficult to study in a traditional laboratory.

Examination of oil recovery methods such as polymer water-flooding or thermogas deposition require even more expensive equipment and more complicated experiments, resulting into even major companies having to resort to very few experiments per object. This has a detrimental effect on quality of project design in general, reduces oil recovery and profitability of field development.

Core material is an extremely valuable source of information about subsurface resources. However, core samples usually degrade over time—either disintegrate or deteriorate in properties, which also represents a significant drawback of traditional core analysis laboratory studies.

Due to the issues of the traditional approach outlined above, methods of digital petrophysics are being actively developed recently. This complex technology consists of several stages (see FIG. 1):

1) Multi-scale core analysis using computed tomography

2) Segmentation and processing of tomography images

3) Mathematical modeling using high-performance computing technologies

4) Integration of results obtained at multiple scales into the core model

Several groups use similar approaches to core analyses (see e.g. Dvorkin J. et al., Method for determining permeability of rock formation using computer tomograpic images thereof, patent U.S. Pat. No. 8,081,802 B2). However, until now the technology involved the utilization of tomographic image segmentation into pixels representing rock skeleton and void space, which does not always allow obtaining accurate enough results.

In the present application, a method of core analysis and construction of core digital model not involving segmentation is suggested.

### DISCLOSURE OF INVENTION

The present invention relates to the method for obtaining characteristic three-dimensional model of a porous material sample for analysis of permeability characteristics.

The technical result of the invention is the improvement of accuracy and reliability of the permeability values obtained for porous material samples without the need for additional financial and human resources.

The above technical result is achieved through the application of a sequence of actions involved in the proposed method for obtaining a characteristic three-dimensional model of a porous material sample for permeability properties analysis, comprising:

1) obtaining three-dimensional tomographic image of the material sample via computed tomography,

2) determining the regions of this three-dimensional image (sample volume) characterized by homogeneous material structure, and assigning each region a specific volume density value by analyzing the tomographic images,

3) assigning specific porosity values for each pixel of the obtained three-dimensional image,

4) assigning specific absolute permeability values for each pixel of the obtained three-dimensional image,

5) forming the characteristic three-dimensional model of the porous material sample based on the known porosity and permeability values for each pixel of the obtained image,

6) calculating absolute permeability of the entire sample of a porous material, or its part, along any direction using computational fluid dynamics laws.

According to the invention, identification of regions with homogeneous structure of the material is performed based on expert opinion or analysis of histograms of obtained tomographic images. In the first case, the density values of the material are obtained from the experimental data, which increases the accuracy of the results.

According to the invention, the material porosity values for each pixel of the obtained image are calculated by multiplying the numerical value of the tomographic brightness of each pixel of the tomographic image by the average value of the density in the region to which this pixel belongs.

Based on the values of porosity at each pixel of the resulting image, the permeability values for each distinct pixel are determined using formulas describing analytical dependencies between the two variables.

Further, in accordance with the claimed method, the characteristic three-dimensional model of the investigated sample is formed based on the values of porosity and permeability for each pixel of the sample.

Thereafter, absolute permeability of the entire sample, or its segment, is determined For this, formulas based of the laws of fluid and gas dynamics are utilized.

### BRIEF DESCRIPTION OF DRAWING

FIG. 1 shows an image of a three-dimensional brightness distribution of the porous material sample obtained through micro-tomography.

FIG. 2 shows one of the cross-sections of three-dimensional image by a plane. This image reflects an example of image segmentation attributed to the known methods. Pores are shown in black whereas the material of the porous object is shown in white.

FIG. 3 shows a visualization of the three-dimensional void space model. Shades of grey indicate void space of the object.

FIG. 4 shows the result of simulation of fluid dynamics in the pore space of the sample. Lines show the direction of the fluid transportation, shades of gray indicate flow rate.

FIG. 5 shows a three-dimensional image, divided by a black line into two regions each reflecting areas with different volume densities in accordance with the claimed method. Material in region I has density R_{I} and material in region II has density R_{II}.

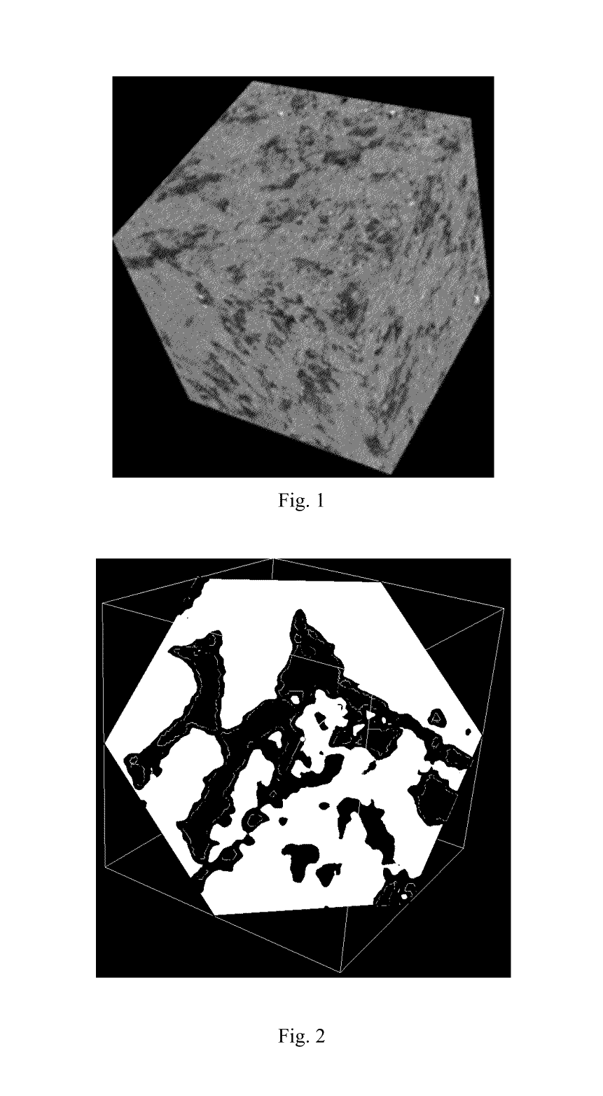

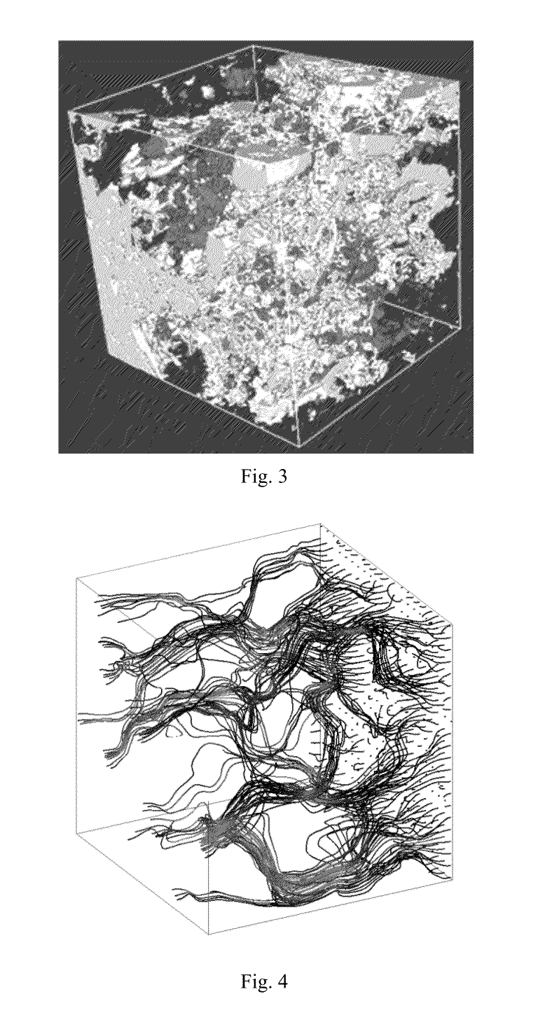

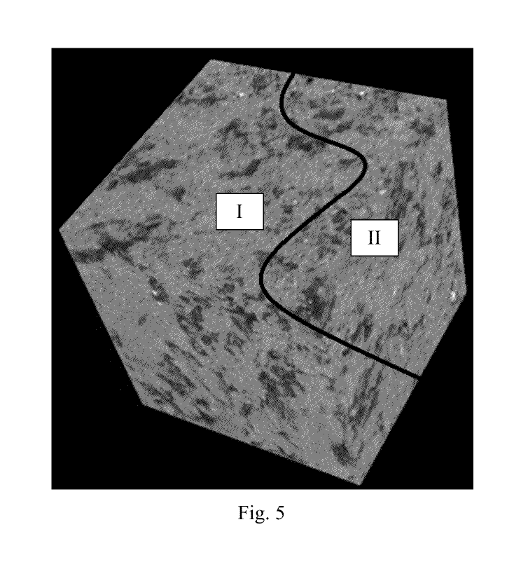

### EMBODIMENTS

In the description of the present invention, as an example the claimed technology is applied to the cylindrically shaped core sample. This fact obviously cannot be considered a factor limiting the scope of possible applications of the claimed method to any other designs and forms of porous media, including drill cuttings.

First of all, core is lifted to the surface in the process of drilling and taken to the laboratory, where typically a smaller size sample is cut out for further micro tomography investigation.

Further, tomographic study of the sample is performed with sufficient resolution (with the necessary size of the pixels on the tomographic image). The result is a set of sequential images of the core, each of which is represented by a set of pixels having different shades of gray—ranging from pure white to pure black. Herein white color corresponds to the maximum bulk density in the volume, black correspond to the minimum.

The next step is to distinguish regions of the material sample that are homogeneous in density. This step may be performed with the help of assistive technologies on the basis of expert opinion and experimental data or using automated algorithms for tomographic images processing. As a result of the region division, N sub-regions with densities R₁, R₂, . . . R_{N} are obtained.

In this case, for each pixel jin the sub-region i(i=1,2 . . . N) the following equality characterizing average porosity within the pixel volume holds: φⱼ=cρⱼ/Rᵢ, where ρⱼ is the brightness value of the pixel (x-ray density) andcis some calibration constant.

Further, numerical values of absolute permeability are obtained for each pixel. There is a number of analytical dependences describing connection between porosity and permeability. Herein, Kozeny-Carman model is utilized for this purpose represented by formula k=d²φ³/[72τ²(1−φ)²], where k is the absolute permeability value, φis porosity of the material sample, dis average grain size within the sample, and τis pore channel tortuosity value.

The result is a three-dimensional structural model of the core with the values of porosity and permeability defined for each pixel. Using this model, the heterogeneity of the core structure and its capacitive properties can be examined. Furthermore, by using such digital representation of the core, absolute permeability in any direction can be efficiently calculated. This is accomplished by applying one of the methods of computational fluid dynamics (CFD).

Herein the problem of filtration in the porous media is solved by means of the modified algorithm based on lattice Boltzmann model (see e.g. Zhaoli Guo, T. S. Zhao, Lattice Boltzmann model for incompressible flows through porous media, Phys. Rev. E 66, 036304 (2002). This approach uses only local porosity and permeability at each voxel to simulate hydrodynamic parameters. In our case, this approach was used to calculate the permeability of the porous material three-dimensional model.

The described approach to constructing a three-dimensional model of the core and obtaining its absolute permeability has several advantages over similar methods (see e.g. Dvorkin J. et al., Method for determining permeability of rock formation using computer tomograpic images thereof, patent U.S. Pat. No. 8,081,802 B2).

First, the proposed method has higher reliability due to the elimination of highly arguable step of separating rock from the pore space, since certain portion of porosity cannot possibly be detected regardless of the tomography resolution. E.g., pores of size 300 nm are not possible to segment at the resolution of 1 micron. At the same time, the proposed method uses the full set of source tomographic data—full brightness image of the core.

Second, an important distinctive feature of the claimed method is that it utilizes additional data regarding the composition of the core material, which is obtained without the use of tomography—e.g. from experts, via thin slices study, elemental analysis etc. This feature makes the core model more informative and accurate.

Third, the claimed method utilizes porosity and permeability values individually calculated at each point of the volume. This is not performed in analogous procedures and can significantly increase the reliability and accuracy of the results.

1. Method for producing a three-dimensional characteristic model of a porous material sample for analysis of permeability characteristics, comprising acquisition of the three-dimensional tomographic image of the sample material, identification of regions with homogeneous material structure and assignment of specific densities to each such region, assignment of specific porosity values for each pixel, assignment of specific absolute permeability values for each pixel, formation of the characteristic three-dimensional model based on the porosity and permeability values for each pixel, calculating absolute permeability for the entire sample or its segment in any direction by computational fluid dynamics methods.

2. The method of claim 1, wherein determining the regions with homogeneous material structure is performed based on the expert opinion or the analysis of histograms obtained for tomographic images.

3. The method of claim 1, wherein the porosity value for each pixel of the obtained image is calculated by multiplying the numerical value of the tomographic brightness value of each pixel by the density of the material in the region where this pixel belongs.

4. The method of claim 1, wherein the permeability value for each pixel of the resulting image is determined via formula describing its analytical dependency on porosity.

5. The method of claim 1, wherein the absolute permeability value of the porous material sample or a segment thereof is determined using the laws of fluid dynamics.
